(19) United States
(12) Patent Application Publication
(10) Pub. No.: US 2015/0356525 A1
(43) Pub. Date: Dec. 10, 2015

(54) SYSTEMS AND METHODS FOR ALTERNATIVE DIGITAL CURRENCY

(71) Applicants: Frederic Bonnevay, Paris (FR); Edouard Tetreau, Paris (FR); Pierre Bellanger, Paris (FR)

(72) Inventors: Frederic Bonnevay, Paris (FR); Edouard Tetreau, Paris (FR); Pierre Bellanger, Paris (FR)

(21) Appl. No.: 14/735,012

(22) Filed: Jun. 9, 2015

Related U.S. Application Data
(60) Provisional application No. 62/009,809, filed on Jun. 9, 2014.

(51) Int. Cl. G06Q 20/06; G06Q 40/06

(52) U.S. Cl. CPC G06Q 20/065; G06Q 40/06

(57) ABSTRACT

In one embodiment, a system for mobile alternative currency transforms accumulated private financial liabilities into a means of digital payment. Advantageously, debtors are provided with liquidity, typically in the form of additional spending power. Providers of goods and services, typically retailers, can also increase revenue while creditors are provided with a net financial enhancement mechanism applicable to their claims and additional net profits.

### CROSS-REFERENCE TO RELATED APPLICATIONS

This application claims priority to U.S. provisional patent application, Ser. No. 62/009,809, filed on Jun. 9, 2014. Priority to the provisional applications is expressly claimed, and the disclosure of the application is hereby incorporated herein by reference in its entirety and for all purposes. An application for a foreign filing license was filed in France on Dec. 24, 2013, and granted on Jan. 7, 2014, reference no. CV/PW-DIV1130242.

### FIELD

Embodiments are directed to systems and methods for an alternative digital method of payment with which to conduct transactions electronically, and more specifically, to the abstraction of the transformation accumulated financial liabilities into a digital means of payment backed by financial claims.

### BACKGROUND

Household debt has grown dramatically over the past two decades. The financial crisis has had a significant and lasting impact on spending power and on the retail sector's growth perspectives. As a consequence, the credit quality of loan portfolios sitting on bank balance sheets has been hit, leading to a massive accounting impact.

The sharp increase in accumulated liabilities is having a substantial impact on transaction dynamics. Consumers and companies alike face a setback in overall revenues, an uncertain business climate, and, as a consequence, a net reduction in credit availability due to an increase in perceived counterparty risk.

Accordingly, a need exists for improved systems and methods for transforming the accumulated private financial liabilities into a means of payment and to accumulate data throughout exchanges to represent a capital to overcome the aforementioned obstacles and deficiencies of prior art systems.

### BRIEF DESCRIPTION OF THE DRAWINGS

FIG. 1 illustrates a conventional state of an indebted consumer accumulating liabilities during a typical transaction;

FIG. 2 illustrates an exemplary application of an indebted consumer using an alternative digital currency in accordance with one embodiment of the present disclosure;

FIG. 3 illustrates an alternative application of an indebted consumer using the alternative digital currency with a funded discount in accordance with one embodiment of the present disclosure;

FIG. 4 illustrates an alternative application of an indebted consumer using the alternative digital currency with a funded discount in accordance with one embodiment of the present disclosure; and

FIG. 5 illustrates an exemplary computer architecture for use with the present system, according to one embodiment.

### DETAILED DESCRIPTION OF PREFERRED EMBODIMENTS

The language used to disclose various embodiments describes, but should not limit, the scope of the claims. For example, in the following description, for purposes of clarity and conciseness of the description, not all of the numerous components shown in the schematic are described. The numerous components are shown in the drawings to provide a person of ordinary skill in the art a thorough enabling disclosure. The operation of many of the components would be understood and apparent to one skilled in the art. Similarly, the reader is to understand that the specific ordering and combination of process actions described is merely illustrative, and the disclosure may be performed using different or additional process actions, or a different combination of process actions.

Each of the additional features and teachings disclosed herein can be utilized separately or in conjunction with other features and teachings to provide alternative digital currency. Representative examples using many of these additional features and teachings, both separately and in combination, are described in further detail with reference to the attached drawings. This detailed description is merely intended for illustration purposes to teach a person of skill in the art further details for practicing preferred aspects of the present teachings and is not intended to limit the scope of the claims. Therefore, combinations of features disclosed in the detailed description may not be necessary to practice the teachings in the broadest sense, and are instead taught merely to describe particularly representative examples of the present disclosure. Additionally and obviously, features may be added or subtracted as desired without departing from the broader spirit and scope of the disclosure. Accordingly, the disclosure is not to be restricted except in light of the attached claims and their equivalents.

Mobile Alternative Currency System (“MAX”) units are securities whose monetary value is backed by certain claims accumulated by debtors. MAX units can be distributed and circulated, e.g., through magnetic stripe cards, computer systems, or mobile devices, in digital format, as detailed below (c.f. Paras. [0017] to [0022].).

Every MAX unit has a singular ID related to an individual claim (having been duly serviced in actual unit of account (i.e., non-virtual) by the debtor, at the time of issuance of the corresponding MAX unit). In one embodiment, the singular ID is unique (so as to link them to a one-to-one mapping with their underlying debt units) and new singular ID's can be incremented to keep track of the identity of their debtor holder and the transactions which they are involved.

Every MAX unit will go through a series of exchanges, of which it will keep track in digital format, by collecting data related to its various holders and the transactions in which it was involved. The singular ID and exchange record of every MAX unit will guarantee its integrity and compliance with the MAX exchange system. The singular ID and MAX unit exchange record (a “MAX Unit ID” and “MAX Exchange Record,” respectively) consist in strings of alphabetic and numerical characters randomly generated using a standard algorithm (from a probability distribution or otherwise), on the basis of one MAX user ID, one MAX Unit ID, and one transaction ID per user, unit, and transaction, respectively, and thereafter encrypted.

The MAX units can be distributed and circulated through in various ways, such as discussed above.

Any individual user of the MAX system, i.e., any person entitled to exchange MAX units against goods and services at a partner retailer (respectively, the “MAX User” and the “Retailer”) will be identified with a MAX account (the “MAX Account”) where the individual MAX unit IDs held by the Max User will be stored. To perform any transaction, access his or her record of transactions or, among other actions, see the remaining balance of MAX units held, an individual user ID and a secure PIN code (the “MAX User ID” and the “MAX User PIN”, respectively), automatically generated by the administrator of the MAX system and possibly modified by the MAX User, though always on a bijective basis (e.g., one MAX User ID per MAX User), will be required for identification purposes (the “MAX Identification Process” or the “Identification Process”). This Identification Process can be completed in a variety of ways, depending on the distribution and circulation means on which the MAX system will be based.

In one embodiment, magnetic stripe cards can be edited and distributed by the MAX system administrators to the end users of the MAX system, i.e., the consumers who will use MAX units to purchase goods and services (henceforth, a “MAX Card” or “MAX Cards”). In this hypothesis, the corresponding MAX Card, just as a standard credit card and using the same encryption means, will store information regarding the MAX Card holder's singular MAX User ID. Upon making a payment with MAX units, the MAX Card holder will swipe the MAX Card into a magnetic card reader connected to the MAX system administrator's database (comprising the MAX Exchange Record) with which every MAX unit ID held by the user are stored. As a result of the purchase, (i) a settlement-compensation process (the “Settlement”) will take place, whereby the relevant number of MAX units, selected from those held by the user by order of acquisition then by numerical and alphabetical order, will be subtracted from the user's MAX Use Account and transferred to that of the retailer, if this number is lower or equal to that required to perform the transaction, (ii) while a MAX Transaction ID will be generated, through standard random generation and encryption techniques, added to the MAX Exchange Record, and (iii) appended to the MAX Unit ID of all MAX units involved in the transaction. It is important to note that the latter process will not affect the string of characters that previously formed the MAX Unit ID, but will rather extend it to track its circulation history. (ii) and (iii) will be handled by the MAX system administrator. A receipt, on which a record of the transaction will be printed, will then be given by the cashier (human or automatic) to the user. If the MAX units required to perform the transaction is strictly larger than that of the number of MAX units held by the user on his MAX account, the transaction will fail, the purchase will be refused, and no further action will be taken as a result of this transaction attempt.

In an exemplary embodiment, a computer system can also be used, whereby a computer terminal linked to the MAX System administrator database and MAX Exchange Record will allow the user to exchange MAX units against goods and services at a retailer by entering his individual MAX User ID into the computer terminal, prior, if the Identification Process is successful, to confirming the terms of the transaction (i.e., the number of MAX units swapped against the list of goods and services to be purchased), the transaction will be executed according to the Settlement process, and the corresponding number of MAX Units, selected by chronological order of acquisition then by alphabetic/numerical order will be subtracted from the MAX User Account of the MAX User and transferred to that of the Retailer, should the number of MAX units held by the account be less than or equal to that required to purchase the intended goods and services. Also, a MAX Transaction ID will be generated, stored in the MAX Exchange Record, and appended to the individual MAX Unit IDs of all MAX Units involved in the transaction. In any other case, the transaction will be rejected and no further action will be taken automatically. In all cases, the cashier or the terminal will print a transaction record to be given to the MAX User.

In another embodiment, mobile devices can also be used to complete the Identification Process and execute MAX system transactions between a MAX User and a Retailer. In this case, the MAX User will be able to download on his mobile device an electronic wallet application (the “Application”) developed by the MAX administration system granting direct access to his MAX User Account and enabling him or her to operate standard seamless payments, possibly based on technology developed by a third-party. As an advantageous of this Application, the MAX User will establish a connection between the cashier's terminal and his MAX User Account by placing his or her mobile device in front of the suitably-equipped cashier terminal, before, if required, entering the Identification Process and the Settlement phases, while a MAX Transaction ID will be generated, as detailed above, stored in the MAX Exchange Record and appended to the MAX Unit IDs of the MAX units involved in the transaction. It should be noted that this method is a mere variation on the above, computer terminal-run method. Its key advantage lies in the fact that, thanks to the seamless technology implemented on the MAX User's mobile device, the Identification Process can be performed automatically, without making it necessary for the MAX User to enter his MAX User ID and MAX User PIN.

A central processing server will store (and, if it so decides, share) this data in order to monetize it, in full compliance with applicable privacy laws.

As an advantage, the system uses the liabilities accumulated by individual debtors to increase their spending potential. Accordingly, spending power is given back to both consumers and retailers. Credit quality is enhanced to the benefit of credit institutions and exclusive data is generated to the benefit of both retailers and credit institutions.

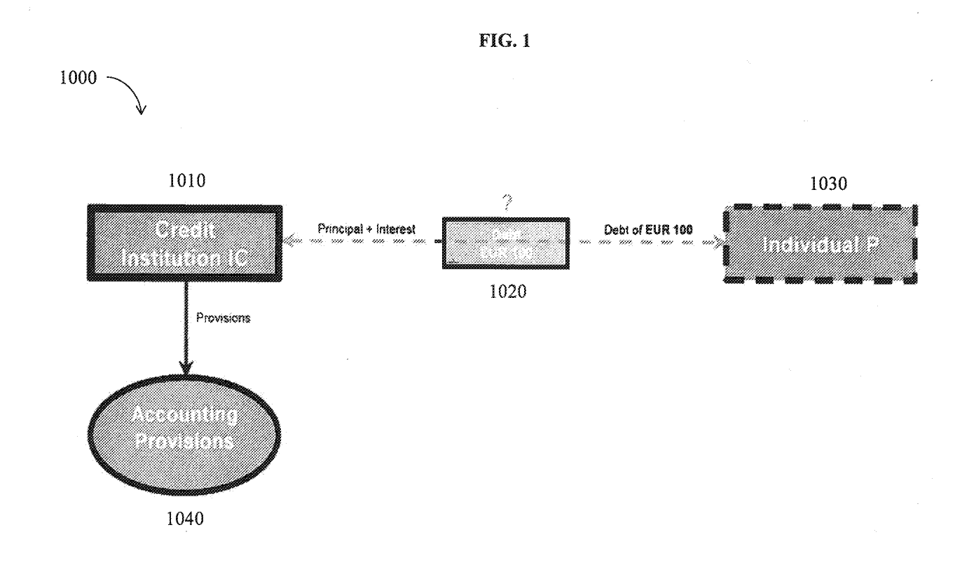

Turning to FIG. 1, a conventional transaction 1000 is illustrated. An individual 1030 accumulates a private financial liability from a creditor 1010. The creditor 1010 can be any entity, public or private. For example, in the following illustration, the creditor 1010 will be assumed to be a credit institution. Accordingly, the creditor 1010 holds a financial claim of debt 1020 (e.g., 100 euros) on the individual 1030. The individual 1030 does not have enough liquidity to cover both (i) his financial obligations vis-à-vis the creditor 1010 and (ii) his or its other needs. As part of this trade-off, the individual 1030 must necessarily forego the financial obligations and his or its other needs. Due to likely default of the individual 1030, the creditor 1010 has or is likely to depreciate the value of its claim, in whole or in part. The creditor 1010 has already written off, in its accounts, the claim at a rate N of its value, and has already taken steps towards recovering the amount it is owed by the individual 1030. Once the creditor 1010 decides that the claim of debt 1020 is non-recoverable, the creditor 1010 creates a corresponding accounting provision 1040.

As described above, these typical liabilities accumulated by individual debtors (e.g., individual 1030) can generate a setback in overall revenues, an uncertain business climate, and, as a consequence, a net reduction in credit availability due to an increase in perceived counterparty risk. However, these liabilities, instead, can be transformed into units of exchange, the MAX units, to increase spending power and reverse the aforementioned dynamics.

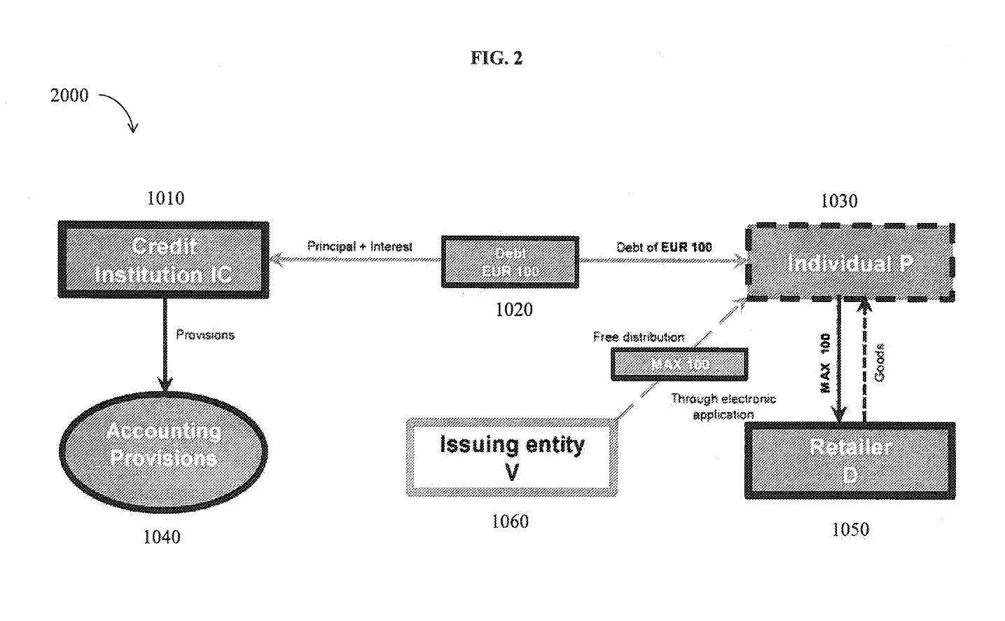

With reference now to FIG. 2, a sample transaction 2000 wherein MAX units are issued for increasing spending potential is illustrated. As shown, once the claim against the individual 1030 is non-recoverable, the creditor 1010 offers the individual 1030 a bargain whereby the individual 1030 duly services his debt 1020 in exchanges for MAX 100, providing the individual 1030 with the same spending power at a specific entity, such as a retailer 1050. In one embodiment, the retailer 1050 can be any entity towards which the individual 1030 either already has a financial obligation to or wishes to buy goods and services from.

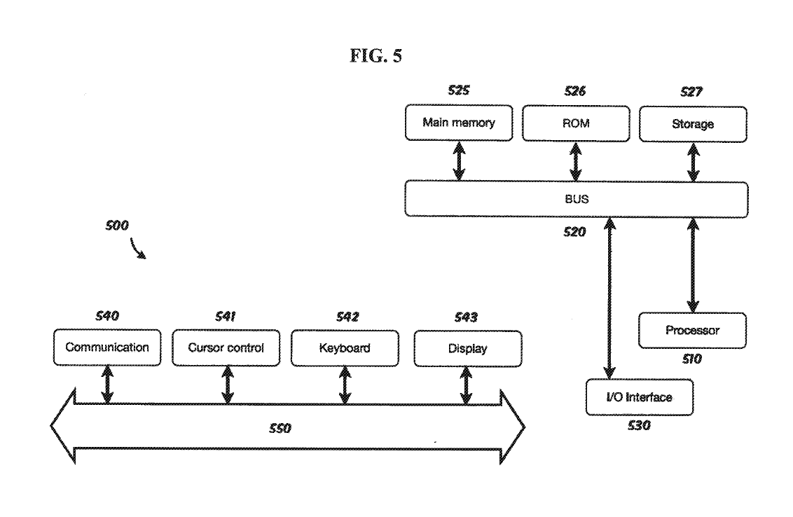

For example, in FIG. 2, retailer 1050 will be assumed to be a retailer where individual 1030 can buy goods. The MAX securities are issued by an independent entity 1060 and are placed with the individual 1030 at no cost, through a downloadable electronic application (e.g., the system described in FIG. 5). By accepting the offer from the creditor 1010, the individual 1030 experiences an immediate rise in spending power of the debt 1020 (i.e., in the form of an equal, or equivalent, amount in MAX 100) to be spent at the retailer 1050. In one embodiment, the debt 1020 is selected based on several key characteristics including, but not limited to, a high provision ratio due to a state of near insolvency on the side of the individual 1030, the existence of other financial obligations to be covered (through MAX-denominated payments), and so on.

The independent entity 1060 can be the central entity of the transaction 2000. In a preferred embodiment, the independent entity 1060 issues the MAX units distributed by the creditor 1010, maintains metrics regarding MAX transfers and transactions, collects the corresponding data, executes exchanges of MAX against the debt currency (e.g., EUR, USD, and so on) amount be paid, and retain a fee in the process thereof.

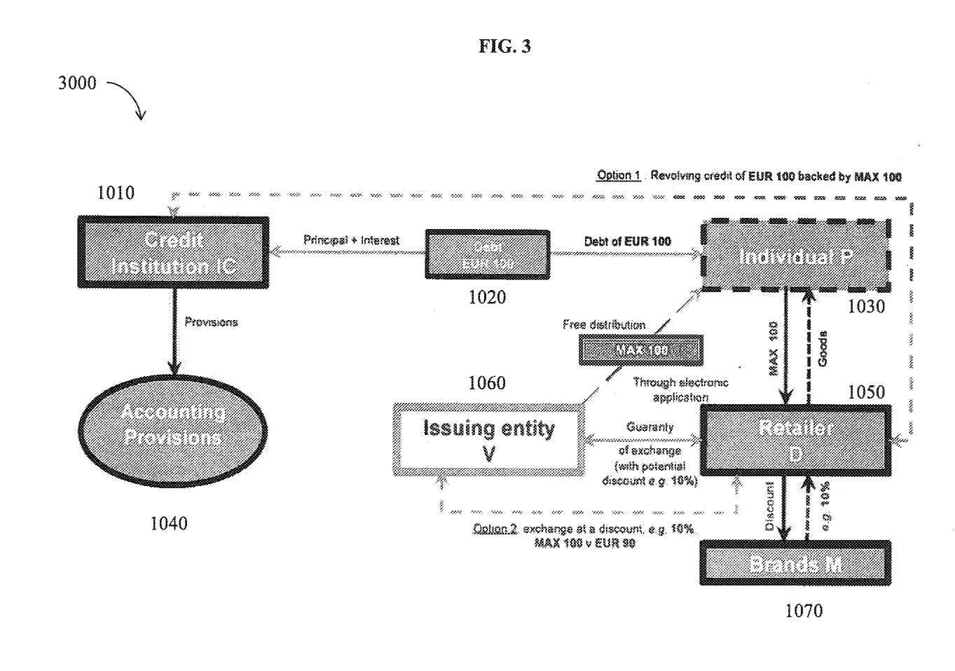

Turning to FIG. 3, when the individual 1030 makes a transaction with the retailer 1050, the retailer 1050 accepts payments in MAX units in exchange for goods having an equivalent nominal price in actual unit of account (e.g., euros, dollars, and so on) based on a guaranty of exchange of MAX in actual unit of account with a discount. This discount ultimately can be funded by the retailer 1050 and/or by suppliers 1070, who is a counterparty of increased sales.

Thereafter, the retailer 1050 accumulates MAX units, which, under a guaranty agreement with the independent entity 1060, allows the retailer 1050 to either:

a) obtain an exchange for an equal number of actual unit of account, with an exchange fee to be paid to the independent entity 1060 (e.g., percentage A of the requested amount in actual unit of account); or

b) receive a revolving loan in actual unit of account from the independent entity 1060, the volume of the loan being equal to the number of MAX units the retailer 1050 gives the independent entity 1060 as a guaranty.

The independent entity 1060 is able to execute both a) and b) through funding provided by the creditor 1010, with the creditor 1010 retaining an amount equal to the differential between (i) the debt servicing amount initially depreciated and the sums ultimately received from the individual 1030, and (ii) the amounts transferred to the independent entity 1060 in order to fund the exchange of MAX units against actual unit of account. The independent entity 1060 is then owed, by the creditor 1010, the number of actual unit of account, with an exchange fee to be paid to the independent entity 1060 (e.g., percentage A of the requested amount in actual unit of account) in addition to a margin B rate charged by the independent entity 1060.

The retailer 10250 pays its own suppliers a total loan amount multiplied by the difference of the discounted rate A and its own margin C (i.e., 1-A-C), which enables the retailer 1050 to limit the cost it has to bear for participating to the MAX system and increasing its revenues.

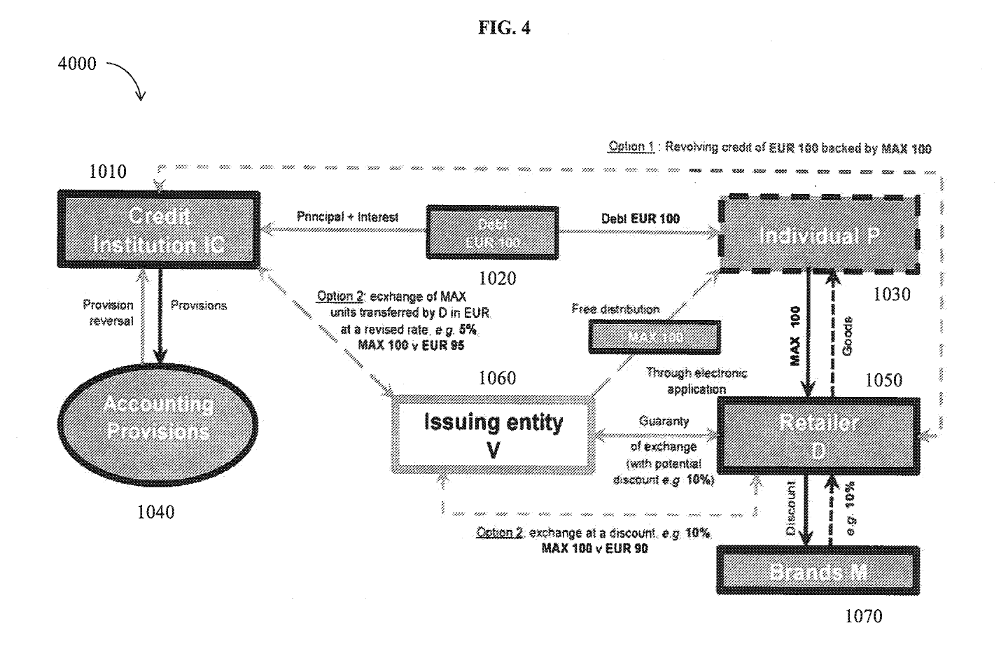

With reference to FIG. 4, the independent entity 1060 must finance the exchange of actual unit of account against MAX or finance the loans backed by MAX units. In either case, the independent entity 1060 remains the sole owner of the MAX units and obtains the actual unit of account-denominated financing requested by the creditor 1010. As further illustrated in FIG. 4, using option a) above, the creditor 1010 retains an exchange spread.

In one embodiment, converting the initial debt into fresh spending power can only be achieved if the differential kept by the creditor 101, at the end of the process is greater than or equal to the book value of the claim, one accounting provisions are subtracted. Stated in another way, the difference between the discounted rate A and the margin rate B charged by the independent entity 1060 (i.e., A-B) must be greater than or equal to (100—the claim at a rate N of its value).

As illustrated above, the MAX system is based on the crystallization of a debt that will be used as a store of value. Advantageously, all stakeholders can benefit from the unlimited circulation of MAX. For example, the individual 1030 receives a financial boost and the ability to consume again without having to forego his private consumption. The creditor 1010 has a balance sheet enhanced by debts deemed irrecoverable, now being attributed at a value (e.g., 5%) or converted in new debts attached to a more creditworthy debtor, generating a net profit for the creditor 1010. The creditor 1010 is able to avoid costly legal action while protecting or improving its image with its client base. Even further, the retailer 1050 is able to promote its community brand to be ahead of its competition, to generate new revenues, and to offer a new pricing model to the brands it distributes. The suppliers 1070 can use MAX units as a new promotional tool yielding new sources of revenues and the possibility to sell certain products exclusively through MAX units. The independent entity 1060 is provided a fair remuneration for its services and the growth of the overall economy is accelerated to build new purchasing power for the overall population—notably the underprivileged. There is no new public debt and no new taxes or government spending.

FIG. 5 illustrates an exemplary computer architecture for use with the present system, according to one embodiment. One embodiment of architecture 500 comprises a system bus 520 for communicating information, and a processor 510 coupled to bus 520 for processing information. Architecture 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Architecture 500 also may include a read only memory (ROM) and/or other static storage device 526 coupled to bus 520 for storing static information and instructions used by processor 510.

A data storage device 527 such as a magnetic disk or optical disc and its corresponding drive may also be coupled to computer system 500 for storing information and instructions. Architecture 500 can also be coupled to a second I/O bus 550 via an I/O interface 530. A plurality of I/O devices may be coupled to I/O bus 550, including a display device 543, an input device (e.g., an alphanumeric input device 542 and/or a cursor control device 541).

The communication device 540 allows for access to other computers (servers or clients) via a network. The communication device 540 may comprise one or more modems, network interface cards, wireless network interfaces or other well known interface devices, such as those used for coupling to Ethernet, token ring, or other types of networks.

In one embodiment, computer system 500 is preferably an Internet-based communication system and includes, but is not limited to, desktop computers, laptop computers, mobile phones, personal digital assistants (“PDAs”), multimedia players, set top boxes, and other programmable consumer electronics, multiprocessor systems, microprocessor-based systems, and distributed computing environments.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

What is claimed is:

1. A system for alternative digital currency comprising:
a central system regulator for transforming existing, accumulated debt into securities that serve as a means of digital payment for anchoring the created securities to actual currency.

2. A method for converting accumulated financial liabilities into an alternative digital currency backed by financial claims comprising:
writing off the accumulated financial liabilities at a rate N of its value;
requesting said alternative digital currency;
issuing said alternative digital currency bearing an amount X equivalent to a creditor and configured to be accepted at a market leading retailer; and
using said alternative digital currency at the market leading retailer for at least one of goods and services,
wherein the market leading retailers receives the amount X multiplied by a discounted rate A from the creditor in exchange for the exclusive access to revenues generated by said alternative digital currency.
